(19) United States
(12) Patent Application Publication
(10) Pub. No.: US 2017/0239878 A1
(43) Pub. Date: Aug. 24, 2017

(54) EXPANDER DEVICE, POROUS FILM PRODUCING APPARATUS, AND POROUS FILM PRODUCING METHOD

(71) Applicant: Sumitomo Chemical Company, Limited, Tokyo (JP)

(72) Inventors: Koichiro WATANABE, Niihama-shi (JP); Yuji TAKAOKA, Niihama-shi (JP)

(21) Appl. No.: 15/434,186

(22) Filed: Feb. 16, 2017

(30) Foreign Application Priority Data
Feb. 19, 2016 (JP) 2016-030299

(51) Int. Cl. B29C 55/08; B29C 33/76; H01M 2/16; B29C 33/72; H01M 10/0525; H01M 2/14

(52) U.S. Cl. CPC B29C 55/08; H01M 10/0525; H01M 2/145; H01M 2/1653; B29C 33/72; B29C 33/76; B29L 2031/3468

(57) ABSTRACT

To prevent wear powder from adhering to a film, an expander roller (21) is used that extends in the width direction of a porous film (F) and that is configured to apply a tension to the porous film (F) in the width direction, and foreign matter adhering to the expander roller (21) is removed from a portion of the outer peripheral surface of the expander roller (21) at which portion the expander roller (21) is in no contact with the porous film (F).

### CROSS-REFERENCE TO RELATED APPLICATIONS

This Nonprovisional application claims priority under 35 U.S.C. §119 on Patent Application No. 2016-030299 filed in Japan on Feb. 19, 2016, the entire contents of which are hereby incorporated by reference.

### TECHNICAL FIELD

The present invention relates to an expander device, a porous film producing apparatus, and a porous film producing method.

### BACKGROUND ART

A heat-resistant separator (porous film) for a lithium-ion secondary battery is produced as follows: While a porous film as a base material is being transferred with use of a transfer system including a transfer roller, the porous film undergoes steps such as (i) a coating step of coating a surface of the porous film with a coating material to be used as a heat-resistant layer and (ii) a drying step of drying the coating material.

The transfer system includes (i) a driving roller configured to apply a transfer tension to a porous film, (ii) a guide roller configured to adjust the transfer direction, and (iii) an expander roller configured to prevent wrinkles in a porous film being transferred.

The use of an expander roller, however, involves friction between the expander roller and the porous film. This friction wears out the porous film, leaving wear powder. Wear powder from a porous film may accumulate on the outer peripheral surface of or inside the expander roller and form a lump to adhere to a porous film. This may hinder a later step.

Patent Literature 1 discloses a technique of causing air to flow out from the inside of an expander roller with use of a compressed air supply source to prevent, for example, water from entering the expander roller.

### CITATION LIST

### Patent Literature

[Patent Literature 1] Publication of Unexamined Japanese Utility Model Application, Jitsukoushou, No 62-22529 (Publication date: Jun. 8, 1987)

### SUMMARY OF INVENTION

### Technical Problem

Causing air to flow out from the inside of an expander roller as in the technique disclosed in Patent Literature 1 will prevent accumulation of wear powder inside the expander roller, but will fail to prevent adherence of wear powder to a porous film.

The present invention has been accomplished in view of the above issue. It is an object of the present invention to provide an expander device, a porous film producing apparatus, and a porous film producing method, with each of which wear powder will not adhere to a film.

### Solution to Problem

In order to attain the above object, an expander device of an embodiment of the present invention includes: an expander roller extending in a width direction of a film transferred, the expander roller being configured to apply a tension to the film in the width direction; and a foreign matter removing section configured to remove foreign matter adhering to the expander roller from a portion of an outer peripheral surface of the expander roller at which portion the expander roller is in no contact with the film.

In order to attain the above object, a porous film producing apparatus of an embodiment of the present invention includes: a transfer system including the expander device; and a processing section configured to process the film, which is being transferred, into a porous film for a battery.

In order to attain the above object, a porous film producing method of an embodiment of the present invention is a porous film producing method for producing a porous film for a battery by processing a film while transferring the film with use of an expander roller extending in a width direction of the film and configured to apply a tension to the film in the width direction, the porous film producing method including the step of removing foreign matter adhering to the expander roller from a portion of an outer peripheral surface of the expander roller at which portion the expander roller is in no contact with the film.

### Advantageous Effects of Invention

An embodiment of the present invention makes it possible to provide an expander device, a porous film producing apparatus, and a porous film producing method, with each of which wear powder will not adhere to a film.

### BRIEF DESCRIPTION OF DRAWINGS

FIG. 1 is a diagram schematically illustrating a cross sectional configuration of a lithium-ion secondary battery.

FIG. 2 shows diagrams each schematically illustrating a state of the lithium-ion secondary battery illustrated in FIG. 1.

FIG. 3 shows diagrams each schematically illustrating a state of a lithium-ion secondary battery having another configuration.

FIG. 4 is a flow diagram schematically illustrating a process of producing the heat-resistant separator.

FIG. 5 is a diagram schematically illustrating how a porous film is transferred with use of a conventional expander roller.

FIG. 6 shows diagrams each schematically illustrating a state in which a porous film is transferred with use of an expander device of Embodiment 1, where (a) of FIG. 6 is an elevational view of the expander device, (b) of FIG. 6 is a side view of an expander roller, (c) of FIG. 6 is a side view of another example expander roller, and (d) of FIG. 6 is a side view of still another example expander roller.

FIG. 7 is a diagram schematically illustrating a state in which a porous film is transferred with use of an expander device in accordance with a variation of Embodiment 1.

FIG. 8 is a diagram schematically illustrating a state in which a porous film is transferred with use of an expander device of Embodiment 2.

FIG. 9 is a diagram schematically illustrating a state in which a porous film is transferred with use of an expander device in accordance with a variation of Embodiment 2.

FIG. 10 is a diagram schematically illustrating a state in which a porous film is transferred with use of an expander device of Embodiment 3.

FIG. 11 is a diagram schematically illustrating a state in which a porous film is transferred with use of an expander device in accordance with a variation of Embodiment 3.

FIG. 12 is a diagram schematically illustrating a state in which a porous film is transferred with use of an expander device in accordance with a variation of Embodiment 3.

### DESCRIPTION OF EMBODIMENTS

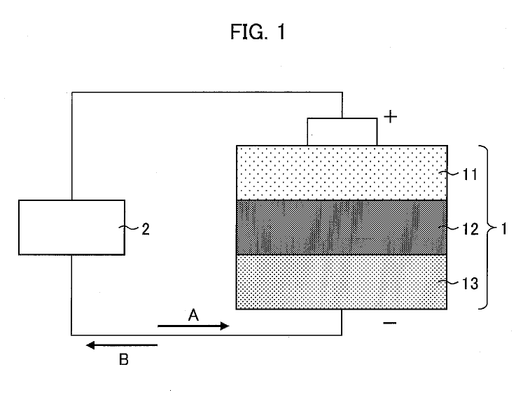

The following description will discuss embodiments of the present invention in detail with reference to FIGS. 1 to 7. The description below deals with a heat-resistant separator for a battery such as a lithium-ion secondary battery as an example film (porous film) in accordance with an embodiment of the present invention.

### Embodiment 1

<Configuration of Lithium-Ion Secondary Battery>

A nonaqueous electrolyte secondary battery, typically a lithium-ion secondary battery, has a high energy density, and is therefore currently widely used not only as batteries for use in devices such as personal computers, mobile phones, and mobile information terminals, and for use in moving bodies such as automobiles and airplanes, but also as stationary batteries contributing to stable power supply.

FIG. 1 is a diagram schematically illustrating a cross-sectional configuration of a lithium-ion secondary battery 1.

As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. While the lithium-ion secondary battery 1 is being charged, electrons move in a direction A. Meanwhile, while the lithium-ion secondary battery 1 is being discharged, electrons move in a direction B.

<Separator>

The separator 12 is provided so as to be sandwiched between the cathode 11 (as a positive electrode) and the anode 13 (as a negative electrode) of the lithium-ion secondary battery 1. While separating the cathode 11 and the anode 13, the separator 12 allows lithium ions to move between the cathode 11 and the anode 13. The separator 12 contains, for example, a polyolefin (for example, polyethylene or polypropylene) as a material thereof.

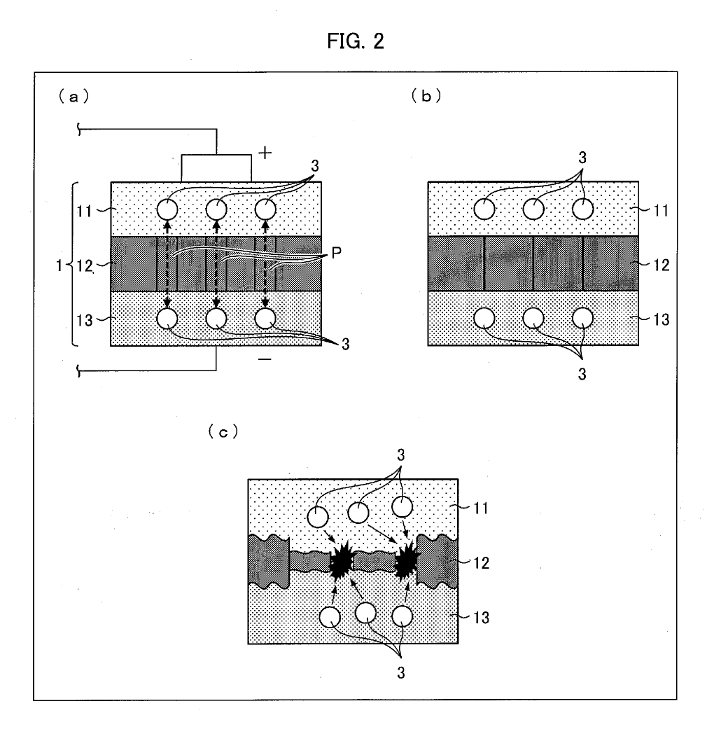

FIG. 2 shows diagrams each schematically illustrating a state of the lithium-ion secondary battery 1 illustrated in FIG. 1. (a) of FIG. 2 illustrates a normal state. (b) of FIG. 2 illustrates a state in which the temperature of the lithium-ion secondary battery 1 has risen. (c) of FIG. 2 illustrates a state in which the temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

Note here that there may be, for example, a case where the lithium-ion secondary battery 1 increases in temperature due to, for example, (i) overcharge of the lithium-ion secondary battery 1 or (ii) a large current caused by a short circuit having occurred in an external device. In such cases, the separator 12 melts or softens, and the pores P are blocked as illustrated in (b) of FIG. 2. As a result, the separator 12 shrinks. This stops the movement of the lithium ions 3, and consequently stops the increase in temperature (described earlier).

Note, however, that the separator 12 suddenly shrinks in a case where the lithium-ion secondary battery 1 sharply increases in temperature. In this case, as illustrated in (c) of FIG. 2, the separator 12 may be broken. Then, the lithium ions 3 leak out from the separator 12 which has been broken, so that the lithium ions 3 do not stop moving back and forth. Thus, the increase in temperature continues.

<Heat-Resistant Separator>

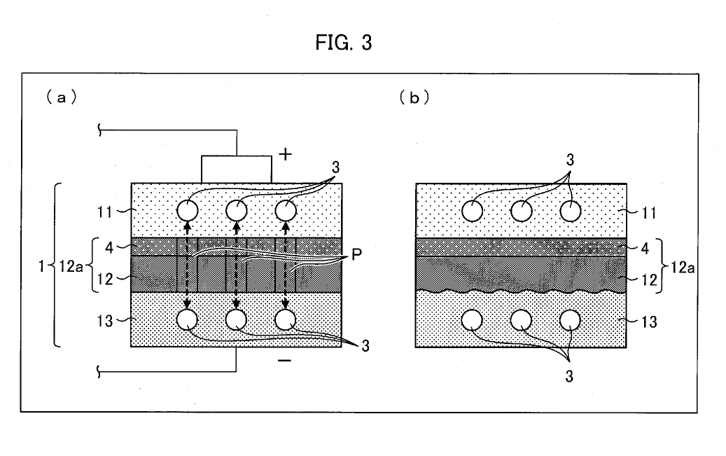

FIG. 3 shows diagrams each schematically illustrating a state of a lithium-ion secondary battery 1 having another configuration. (a) of FIG. 3 illustrates a normal state. (b) of FIG. 3 illustrates a state in which the temperature of the lithium-ion secondary battery 1 has sharply risen.

As illustrated in (a) of FIG. 3, the lithium-ion secondary battery 1 can further include a heat-resistant layer 4. The heat-resistant layer 4 can be provided on the separator 12. (a) of FIG. 3 illustrates a configuration in which a heat-resistant layer 4 as a functional layer is provided on the separator 12. The description below uses the term “heat-resistant separator 12a” to refer to a film that combines the separator 12 and the heat-resistant layer 4 provided thereon.

The configuration illustrated in (a) of FIG. 3 includes a heat-resistant layer 4 laminated on one surface of the separator 12 which surface is on the cathode 11 side. The heat-resistant layer 4 may alternatively be laminated on (i) a surface of the separator 12 which surface is on the anode 13 side or on (ii) both surfaces of the separator 12. Further, the heat-resistant layer 4 is provided with pores that are similar to the pores P. Normally, lithium ions 3 move back and forth through the pores P and the pores of the heat-resistant layer 4. The heat-resistant layer 4 contains, for example, wholly aromatic polyamide (aramid resin) as a material thereof.

As illustrated in (b) of FIG. 3, even in a case where the temperature of the lithium-ion secondary battery 1 has sharply risen and accordingly the separator 12 has melted or softened, the shape of the separator 12 is maintained because the heat-resistant layer 4 supports the separator 12. Thus, such a sharp increase in temperature merely results in melting or softening of the separator 12 and consequent blocking of the pores P. This stops the movement of the lithium ions 3, and consequently stops overdischarge and overcharge (described earlier). The separator 12 is thus prevented from being broken.

<Method for Producing Heat-Resistant Separator (Method for Producing Porous Film>

The following description will discuss how a heat-resistant separator is produced with use of a separator producing apparatus (porous film producing apparatus) of Embodiment 1.

The heat-resistant separator 12a includes (i) a porous film serving as the separator 12 and (ii) a heat-resistant layer laminated thereon. The porous film contains, for example, a polyolefin. The heat-resistant layer may be replaced with a functional layer such as an adhesive layer. A heat-resistant layer is laminated on the porous film by (i) coating a surface of the porous film with, for example, a coating material for the heat-resistant layer and (ii) drying the coating material.

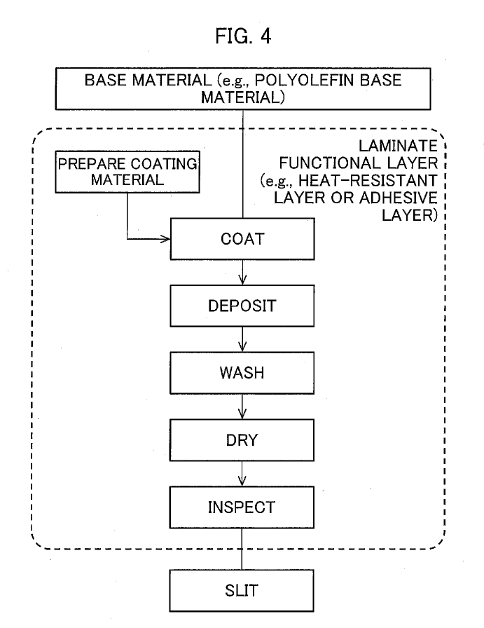

FIG. 4 is a flow diagram schematically illustrating a process of producing the heat-resistant separator.

According to the flow illustrated in FIG. 4, the heat-resistant layer contains wholly aromatic polyamide (aramid resin) as a material, and is laminated on a polyolefin base material.

The process of producing a heat-resistant separator including a heat-resistant layer made of aramid resin includes in sequence (a) a step of unwinding and inspecting a porous film, (b) a step of coating the porous film with a coating material (functional material), (c) a step of depositing the coating material by, for example, humidification, (d) a washing step, (e) a drying step, (f) a coated article inspecting step, and (g) a winding step.

The process of producing a heat-resistant separator including a heat-resistant layer containing an inorganic filler as a main component includes in sequence (a) a step of unwinding and inspecting a porous film, (b) a step of coating the porous film with a coating material (functional material), (e) a drying step, (f) a coated article inspecting step, and (g) a winding step.

Further, the process of producing a heat-resistant separator may include, in addition to the above steps (a) through (g), a base material producing (film forming) step carried out before the unwinding and inspecting step (a) and/or a slitting step carried out after the winding step (g).

The following description will discuss the steps (a) to (g) in sequence.

(a) Unwinding Step and Inspecting Step

The unwinding step is a step of unwinding, from a roller, a porous film as a base material for a heat-resistant separator. The inspecting step is a step of inspecting the unwound porous film before coating it in the next step.

(b) Coating Step

The coating step is a step of coating the porous film unwound in the step (a) with a coating material as a functional material. The description below deals with how a heat-resistant layer is laminated on a porous film. Specifically, the porous film is coated with an N-methyl-pyrrolidone (NMP) solution of aramid, which solution serves as a coating material for the heat-resistant layer. Note that the heat-resistant layer is not limited to the above aramid heat-resistant layer. For example, the porous film can be coated with, for example, a suspension containing an inorganic filler (for example, a suspension containing alumina, carboxymethylcellulose, and water), which suspension serves as a coating material for the heat-resistant layer. The method for coating the porous film with a coating material is not particularly limited provided that uniform wet coating can be carried out by the method. The method can be exemplified by various methods such as a capillary coating method, a slit die coating method, a spray coating method, a dip coating method, a roller coating method, a screen printing method, a flexo printing method, a gravure coater method, a bar coater method, and a die coater method. The heat-resistant layer 4 has a thickness which can be controlled by (i) adjusting the thickness of the coating material with which the porous film is coated or (ii) adjusting the solid-content concentration of the coating material.

(c) Depositing Step

The depositing step is a step of solidifying the coating material with which the porous film has been coated in the step (b). In a case where the coating material is an NMP solution of aramid, the aramid is solidified by, for example, providing vapor to a coating surface and thereby causing humid deposition.

(d) Washing Step

The washing step is a step of removing the solvent by washing the coating material deposited in the step (c). As a result of removal of the solvent, an aramid heat-resistant layer is formed on the base substrate. In a case where the heat-resistant layer is an aramid heat-resistant layer, water, an aqueous solution, or an alcoholic solution, for example, is suitably used as a washing liquid.

(e) Drying Step

The drying step is a step of drying the heat-resistant separator which has been washed in the step (d). The method for drying the heat-resistant separator is not particularly limited, but can be any of various methods such as (i) a method of bringing the heat-resistant separator into contact with a heated roller and (ii) a method of blowing hot air onto the heat-resistant separator. In a case where a heat-resistant layer is to be formed that contains an inorganic filler as a main component, the porous film is coated with a suspension (coating material) containing an inorganic filler and is subsequently dried, and then the solvent is removed for formation of a heat-resistant layer on the porous film.

(e) Inspecting Step

The inspecting step is a step of inspecting the heat-resistant separator which has been dried. During the inspection, a defective part may be marked as appropriate so that the defective part can be easily removed.

(f) Winding Step

The winding step is a step of winding the heat-resistant separator which has been inspected. The winding can be carried out by appropriately using, for example, a cylindrical core. The wound heat-resistant separator can be, for example, directly shipped in the form of a wide original sheet. Alternatively, if necessary, the wound heat-resistant separator can be formed into a slit separator by being slit so as to have a narrow width such as a product width.

<Production Device>

As described above, the process of producing a heat-resistant separator includes steps such as a coating step, a depositing step, a washing step, a drying step, an inspecting step, and a slitting step. The operation during each step is carried out while the porous film is being subjected to a tension in the longitudinal direction of the porous film for transfer. This allows a heat-resistant separator to be produced.

A separator producing apparatus includes, for example, (i) devices configured to carry out the above steps such as a coating device (processing section), a depositing device, a washing device, a drying device, an inspecting device, and a slitting device, and (ii) a transfer system configured to transfer a porous film to the individual devices.

The transfer system includes (i) a plurality of transfer rollers configured to transfer a porous film and (ii) an expander roller configured to apply a tension to the porous film in its width direction to prevent wrinkles in the porous film.

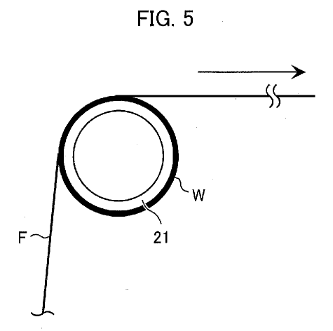

FIG. 5 is a diagram schematically illustrating how a porous film is transferred with use of a conventional expander roller. FIG. 5 shows an arrow to indicate the direction in which a porous film F is transferred. In a case where the transfer system includes an expander roller 21 as illustrated in FIG. 5, there is friction between the expander roller 21 and the porous film F. This friction wears out the porous film F, leaving wear powder W accumulating on the outer peripheral surface (surface) of the expander roller 21. Wear powder W generated by the friction may accumulate inside the expander roller, which is a hollow structure. As a result, the wear powder W accumulated may form a lump to adhere to the porous film F. This may hinder a later step.

A separator producing apparatus 30 of Embodiment 1 can, in contrast, prevent wear powder W from adhering to a porous film F as described below.

<Expander Device>

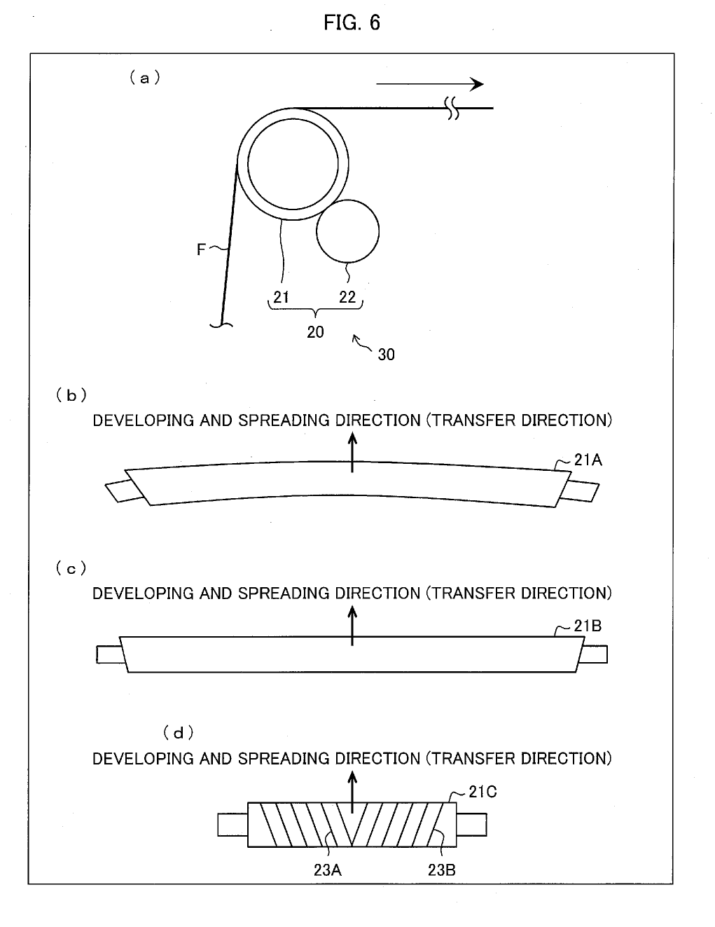

FIG. 6 shows diagrams each schematically illustrating a state in which a porous film is transferred with use of an expander device of Embodiment 1. (a) of FIG. 6 is an elevational view of the expander device. (b) of FIG. 6 is a side view of an expander roller. (c) of FIG. 6 is a side view of another example expander roller. (d) of FIG. 6 is a side view of still another example expander roller.

As illustrated in (a) of FIG. 6, a separator producing apparatus 30 of Embodiment 1 includes an expander device 20. The expander device 20 includes (i) an expander roller 21 extending in the width direction of the porous film F and (ii) an adhesive roller 22 provided in contact with the expander roller 21. The expander roller 21 extending in the width direction of the porous film F means that the expander roller 21 is so oriented to have a longitudinal direction substantially parallel to the width direction of the porous film F.

The expander roller 21 is a substantially cylindrical roller, and is in contact with the porous film F in the longitudinal direction of the expander roller 21. The expander roller 21 applies a tension to the porous film F in its width direction at a portion at which the expander roller 21 is in contact with the porous film F.

The expander roller 21 can be any of various conventionally publicly known rollers. Specific examples include (i) a curved roller 21A (banana roller) having a curved axis as illustrated in (b) of FIG. 6, (ii) a cylindrical roller 21B having a non-curved axis as illustrated in (c) of FIG. 6, and (iii) a roller 21C having grooves 23A and 23B each in the shape of a spiral that curves away from the center toward one of both ends as illustrated in (d) of FIG. 6.

The expander roller 21 may be a driving roller or a driven roller. The expander roller preferably has a smooth curved surface. This configuration eliminates the possibility of accumulation of wear powder of the porous film F in bumps in the surface of the expander roller and facilitates removal of wear powder.

The adhesive roller 22 has an adhesive surface, which serves as an adhesive section (foreign matter removing section) configured to cause foreign matter such as wear powder of the porous film F to adhere to the adhesive section. The adhesive roller 22 is in contact with the expander roller 21 in its longitudinal direction at a portion of the outer peripheral surface of the expander roller 21 at which portion the expander roller 21 is in no contact with the porous film F. With this configuration, even in a case where wear powder (foreign matter) of the porous film F has adhered to the expander roller 21, the adhesive roller 22 can catch wear powder on its surface for removal while the porous film F is being transferred. This configuration can prevent wear powder from accumulating on the outer peripheral surface of the expander roller 21 and thus prevent lumps of the wear powder from adhering to the porous film F.

In a case where wear powder adhering to the porous film F is to be directly removed from the porous film F, the porous film F may be damaged. The expander device 20 of Embodiment 1 is, in contrast, configured to remove, from the outer peripheral surface of the expander roller 21, wear powder that may adhere to the porous film F. This configuration can prevent wear powder from adhering to the porous film F without damaging the porous film F.

<Variations>

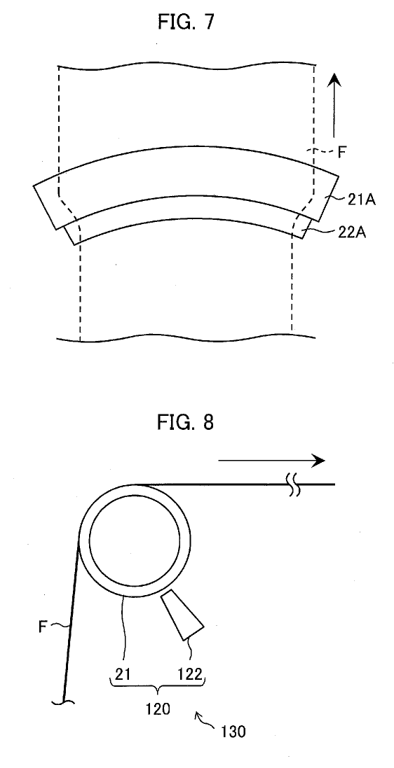

FIG. 7 is a diagram schematically illustrating a state in which a porous film is transferred with use of an expander device in accordance with a variation of Embodiment 1.

As illustrated in FIG. 7, the expander device in accordance with the variation includes (i) a curved expander roller 21A (curved roller 21A) having a curved axis and (ii) an adhesive roller 22A.

The adhesive roller 22A has an axis that is curved at a curvature corresponding to the curvature of the axis of the expander roller 21A. This configuration causes the adhesive roller 22A to be in contact with the expander roller 21A in its longitudinal direction.

In a case where a curved expander roller 21A is used and an adhesive roller 22A is used that also has a curved axis as described above, the adhesive roller 22A can be in close contact with the expander roller 21A. This configuration makes it possible to remove foreign matter such as wear powder from the entire outer peripheral surface of the expander roller 21A.

### Embodiment 2

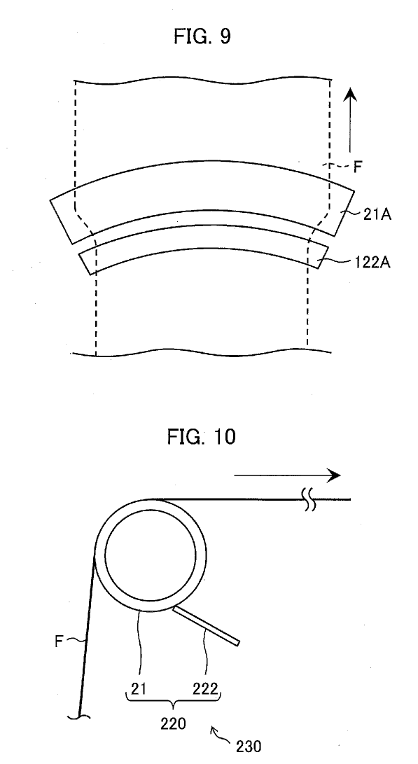

The following description will discuss another embodiment of the present invention with reference to FIGS. 8 and 9. Note that, for convenience of explanation, identical reference numerals are given to members which have respective functions identical with those described in Embodiment 1, and descriptions of the respective members are omitted.

FIG. 8 is a diagram schematically illustrating a state in which a porous film is transferred with use of an expander device of Embodiment 2.

As illustrated in FIG. 8, a separator producing apparatus 130 of Embodiment 2 includes an expander device 120. The expander device 120 includes an expander roller 21 and a sucking device 122.

The sucking device 122 has a tip that serves as a sucking port (sucking section, foreign matter removing section) configured to suck foreign matter such as wear powder of the porous film F. The sucking device 122 is positioned near the expander roller 21 in its longitudinal direction at a portion of the outer peripheral surface of the expander roller 21 at which portion the expander roller 21 is in no contact with the porous film F. With this configuration, even in a case where wear powder (foreign matter) of the porous film F has adhered to the expander roller 21, the sucking device 122 can suck the wear powder through the sucking port for removal while the porous film F is being transferred. This configuration can prevent wear powder from accumulating on the outer peripheral surface of the expander roller 21 and thus prevent lumps of the wear powder from adhering to the porous film F.

Sucking wear powder with use of the sucking device 122 makes it possible to remove wear powder from a wide region of the outer peripheral surface of the expander roller 21. Further, in a case where, for example, the expander device 120 includes an expander roller 21 having an outer peripheral surface with bumps or an expander roller 21 having an outer peripheral surface with a gap or groove, the sucking device 122 can suck wear powder accumulating in the bumps or the like of the outer peripheral surface.

The sucking port of the sucking device 122 is in no contact with the expander roller 21, and provides no resistance to the rotation of the expander roller 21. This eliminates the need to increase the power for rotation of the expander roller 21 in a case where the expander roller 21 has driving force.

<Variations>

FIG. 9 is a diagram schematically illustrating a state in which a porous film is transferred with use of an expander device in accordance with a variation of Embodiment 2.

As illustrated in FIG. 9, the expander device in accordance with the variation includes a curved expander roller 21A (curved roller 21A) having a curved axis and a sucking device 122A.

The sucking device 122A has, at a tip thereof, a sucking port that is curved at a curvature corresponding to the curvature of the axis of the expander roller 21A. This configuration causes the sucking device 122A to be positioned near the expander roller 21A in its longitudinal direction.

In a case where a curved expander roller 21A is used and a sucking device 122A having a curved sucking port is used as described above, the expander roller 21A can be separated from the sucking device 122A by a uniform gap. This configuration makes it possible to remove foreign matter such as wear powder from the entire outer peripheral surface of the expander roller 21A.

### Embodiment 3

The following description will discuss another embodiment of the present invention with reference to FIGS. 10 to 12. Note that, for convenience of explanation, identical reference numerals are given to members which have respective functions identical with those described in Embodiment 1 or 2, and descriptions of the respective members are omitted.

FIG. 10 is a diagram schematically illustrating a state in which a porous film is transferred with use of an expander device of Embodiment 3.

As illustrated in FIG. 10, a separator producing apparatus 230 of Embodiment 3 includes an expander device 220. The expander device 220 includes an expander roller 21 and a scraper 222.

The scraper 222 has a tip that serves as a contact section (foreign matter removing section) configured to scrape foreign matter such as wear powder of the porous film F. The tip of the scraper 222 is in contact with the expander roller 21 in its longitudinal direction at a portion of the outer peripheral surface of the expander roller 21 at which portion the expander roller 21 is in no contact with the porous film F. With this configuration, even in a case where wear powder (foreign matter) of the porous film F has adhered to the expander roller 21, the scraper 222 can scrape the wear powder for removal while the porous film F is being transferred. This configuration can prevent wear powder from accumulating on the outer peripheral surface of the expander roller 21 and thus prevent lumps of the wear powder from adhering to the porous film F.

In a case where a curved expander roller 21A is used that has a curved axis, a scraper 222 is preferably used that has a contact section at a tip which contact section is curved at a curvature corresponding to the curvature of the axis of the expander roller 21A (not shown). This configuration allows the tip of the scraper 222 to be in close contact with the expander roller 21. This in turn makes it possible to remove foreign matter such as wear powder from the entire outer peripheral surface of the expander roller 21.

<Variations>

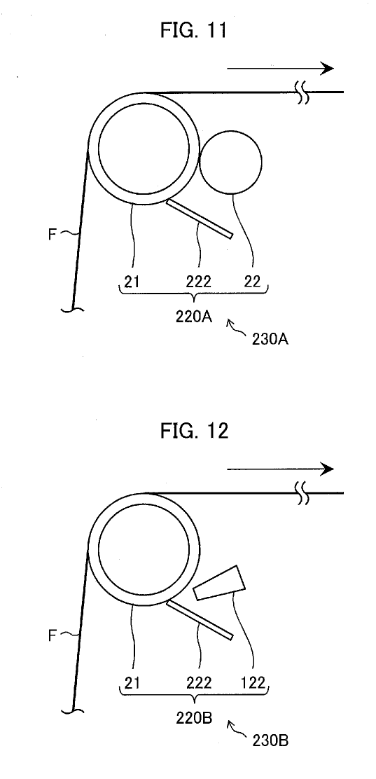

FIGS. 11 and 12 are each a diagram schematically illustrating a state in which a porous film is transferred with use of an expander device in accordance with a variation of Embodiment 3.

As illustrated in FIG. 11, the expander device 220A includes an expander roller 21, a scraper 222, and an adhesive roller 22.

Using an adhesive roller 22 in addition to the scraper 222 as in the present variation allows (i) the scraper 222 to scrape wear powder from the outer peripheral surface of the expander roller 21A (curved roller 21A) and (ii) the adhesive roller 22 to catch the wear powder for recovery. This configuration can prevent such wear powder, which has been scraped from the outer peripheral surface of the expander roller 21A, from adhering to the porous film F.

As illustrated in FIG. 12, an expander device 220B includes an expander roller 21, a scraper 222, and a sucking device 122.

Using a sucking device 122 in addition to the scraper 222 as in the present variation allows (i) the scraper 222 to scrape wear powder from the outer peripheral surface of the expander roller 21A and (ii) the sucking device 122 to suck the wear powder for recovery. This configuration can prevent such wear powder, which has been scraped from the outer peripheral surface of the expander roller 21A, from adhering to the porous film F.

The expander roller 21 is preferably a roller having a curved outer peripheral surface that has no bumps or groove. This configuration can prevent wear powder from accumulating in the bumps or the like in the outer peripheral surface.

<Other Variations>

The respective descriptions of Embodiments 1 to 3 each deal with a method for removing wear powder with use of an adhesive roller 22, a sucking device 122, a scraper 222, and/or the like. The adhesive roller 22 and the like may be positioned near or in contact with the expander roller 21 manually by an operator or mechanically.

The outer peripheral surface of the expander roller 21 may be wiped with cloth or the like instead of using the adhesive roller 22. This configuration makes it possible to efficiently remove wear powder and the like adhering to the outer peripheral surface.

### Embodiment 4

The following description will discuss another embodiment of the present invention. Note that, for convenience of explanation, identical reference numerals are given to members which have respective functions identical with those described in Embodiment 1, 2, or 3, and descriptions of the respective members are omitted.

The respective descriptions of Embodiments 1 to 3 each deal with a heat-resistant separator producing method (porous film producing method) that uses a separator producing apparatus including an expander device 20, 120, 220, 220A, or 220B to allow wear powder adhering to the outer peripheral surface of the expander roller 21 to be removed while a porous film F is being transferred. A porous film producing method in accordance with an embodiment of the present invention is, however, not limited by the above descriptions.

The heat-resistant separator producing method of any of Embodiments 1 to 3 is configured as follows: The transfer of a porous film F is stopped at predetermined timing. While the porous film F is not transferred, the outer peripheral surface of the expander roller 21 is cleaned with an adhesive roller (or a sucking device, a scraper, or the like). This configuration makes it possible to efficiently remove wear powder W accumulating on the outer peripheral surface of the expander roller 21. When the outer peripheral surface of the expander roller 21 is cleaned, the adhesive roller may be positioned in contact with the expander roller 21 manually or pressed against the expander roller 21 mechanically.

When the outer peripheral surface of the expander roller 21 is cleaned, while the porous film F is not transferred, the adhesive roller is brought into contact with a portion of the outer peripheral surface of the expander roller 21 at which portion the expander roller 21 is in no contact with the porous film F, for example, a surface of the expander roller 21 which surface is opposite to a surface at which the expander roller 21 is in contact with a porous film F. In this case, after a portion of the outer peripheral surface of the expander roller 21 is cleaned, the expander roller 21 is rotated by 90 degrees, and then a portion of the outer peripheral surface of the expander roller 21 which portion has not yet been cleaned is cleaned. Repeating this operation can clean the entire outer peripheral surface of the expander roller 21.

The timing at which the transfer of a porous film F is stopped is not particularly limited. The timing may be, for example, (i) when the roller from which a porous film F is unwound is replaced during the unwinding step (that is, when the lot is changed) or (ii) when a porous film F being transferred is broken. As described above, the transfer of a porous film F can be stopped for removal of foreign matter when the supply of the porous film F is discontinued. This makes it possible to remove foreign matter without decreasing the production efficiency. The transfer of a porous film F may be stopped when wear powder W accumulating on the outer peripheral surface of the expander roller 21 reaches a predetermined amount or more and before the wear powder W starts to adversely affect the quality of a heat-resistant separator 12a to be produced.

The heat-resistant separator producing method of any of Embodiments 1 to 3 may be arranged such that the porous film F is cut and a cutting is removed from the transfer path while the porous film F is not transferred so that the porous film F is in no contact with the outer peripheral surface of the expander roller 21, and then the outer peripheral surface of the expander roller 21 is cleaned. After the cleaning, the cutting of the porous film F is joined with the remainder with use of an adhesive tape or the like so that the porous film F can be transferred again. This arrangement allows a heat-resistant separator 12a to be produced while the porous film F is being continuously transferred again.

The outer peripheral surface of the expander roller 21 may be wiped for cleaning with cloth instead of using the adhesive roller. This arrangement makes it possible to easily and efficiently remove foreign matter such as wear powder.

[Recap]

An expander device in accordance with an embodiment of the present invention includes: an expander roller extending in a width direction of a film transferred, the expander roller being configured to apply a tension to the film in the width direction; and a foreign matter removing section configured to remove foreign matter adhering to the expander roller from a portion of an outer peripheral surface of the expander roller at which portion the expander roller is in no contact with the film.

With the above configuration, even in a case where (i) there has been friction between the expander roller and the film, (ii) the friction has caused wear powder (foreign matter) of the film to be generated, and (iii) the wear powder has adhered to the expander roller, such wear powder adhering to the expander roller can be removed. The above configuration can thus prevent wear powder from accumulating on the outer peripheral surface of or inside the expander roller and prevent lumps of the wear powder from adhering to the film.

Removing wear powder adhering to the film directly from the film may damage the film. In contrast, in a case where the above expander device is used to remove, from the outer peripheral surface of the expander roller, wear powder that may adhere to the film, it is possible to prevent wear powder from adhering to the film without damaging the film.

The expander device may be configured such that the foreign matter removing section is an adhesive section; and the adhesive section removes the foreign matter by causing the foreign matter to adhere to a surface of the adhesive section.

With the above configuration, causing wear powder adhering to the outer peripheral surface of the expander roller to adhere to the adhesive section for recovery can prevent the wear powder, which has been removed from the outer peripheral surface of the expander roller, from adhering to the film.

The expander device may be configured such that the expander roller is a curved expander roller having a curved axis; and the adhesive section is an adhesive roller that has an axis curved in correspondence with a curvature of the axis of the expander roller and that is in contact with the expander roller in a longitudinal direction of the expander roller.

With the above configuration, in a case where a curved expander roller is used, The adhesive roller can be in close contact with the expander roller in the longitudinal direction of the expander roller. This makes it possible to remove foreign matter such as wear powder from the entire outer peripheral surface of the expander roller.

The expander device may be configured such that the foreign matter removing section is a sucking section having a sucking port; and the sucking section removes the foreign matter by sucking the foreign matter through the sucking port.

The above configuration makes it possible to suck wear powder adhering to the outer peripheral surface of the expander roller across a wide region for removal. Further, even in a case where an expander roller is used that has an outer peripheral surface with bumps, the above configuration makes it possible to remove wear powder adhering to the bumps of the outer peripheral surface.

The expander device may be configured such that the expander roller is a curved expander roller having a curved axis; and the sucking port is curved in correspondence with a curvature of the axis of the expander roller and is near the expander roller in a longitudinal direction of the expander roller.

With the above configuration, in a case where a curved expander roller is used, the sucking section can be near the expander roller in the longitudinal direction of the expander roller. This makes it possible to remove foreign matter such as wear powder from the entire outer peripheral surface of the expander roller.

The expander device may be configured such that the foreign matter removing section is a scraper; and the scraper removes the foreign matter by scraping the foreign matter.

The above configuration makes it possible to remove wear powder adhering to the outer peripheral surface of the expander roller. Further, the above configuration makes it possible to remove lumps of wear powder accumulating on the outer peripheral surface of the expander roller by scraping the wear powder with use of the scraper.

The expander device may be configured such that the expander roller is a curved expander roller having a curved axis; and the scraper is curved in correspondence with a curvature of the axis of the expander roller and is in contact with the expander roller in a longitudinal direction of the expander roller.

With the above configuration, in a case where a curved expander roller is used, the scraper can be in close contact with the expander roller in the longitudinal direction of the expander roller. This makes it possible to remove foreign matter such as wear powder from the entire outer peripheral surface of the expander roller.

The expander device may be configured such that the outer peripheral surface is a smooth, curved surface.

In a case where the expander roller has an outer peripheral surface with bumps, wear powder more likely accumulates in the bumps. The above configuration makes it less likely for wear powder to accumulate on the outer peripheral surface of the expander roller, and facilitates removing wear powder.

The expander device may be configured such that the expander roller is a driving roller.

The above configuration makes it possible to apply a transfer force to the film with use of the expander roller.

A porous film producing apparatus in accordance with an embodiment of the present invention includes: a transfer system including the expander device; and a processing section configured to process the film, which is being transferred, into a porous film for a battery.

A porous film producing method in accordance with an embodiment of the present invention is a porous film producing method for producing a porous film for a battery by processing a film while transferring the film with use of an expander roller extending in a width direction of the film and configured to apply a tension to the film in the width direction, the porous film producing method including the step of removing foreign matter adhering to the expander roller from a portion of an outer peripheral surface of the expander roller at which portion the expander roller is in no contact with the film.

The porous film producing method may be configured such that the foreign matter is removed from the portion of the outer peripheral surface while the film is being transferred.

The porous film producing method may be configured such that the foreign matter is removed from the portion of the outer peripheral surface while the film is not being transferred.

The above producing method makes it possible to, while the film is not being transferred, remove foreign matter adhering to the expander roller. This makes it possible to remove foreign matter efficiently.

The porous film producing method may be configured such that in a case where supply of the film has been discontinued, transfer of the film is stopped, and the foreign matter is removed.

With the above producing method, at timing at which the supply of the film has been discontinued, the transfer of the film is stopped, and foreign matter is removed. This can avoid decreasing the film production efficiency.

The porous film producing method may further include: cutting the film in the width direction while the film is not being transferred and removing a cutting from a transfer path so that the film is in no contact with the expander roller; removing the foreign matter; and subsequently joining the cutting with a remainder of the film so that the film is transferrable.

The above producing method allows the film to be in no contact with the expander roller. This can facilitate removing foreign matter adhering to the expander roller. Further, joining the cutting with the remainder of the film after removing foreign matter makes it possible to again process the film while transferring the film.

[Supplemental Notes]

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### REFERENCE SIGNS LIST

12 Separator
12a Heat-resistant separator (porous film)
20, 120, 220, 220A, 220B Expander device
21, 21A Expander roller
22, 22A Adhesive roller
30, 130, 230 Separator producing apparatus (porous film producing apparatus)
122, 122A Sucking device
222 Scraper
F Porous film (film)
W Wear powder (foreign matter)

1. An expander device, comprising:
an expander roller extending in a width direction of a film transferred, the expander roller being configured to apply a tension to the film in the width direction; and
a foreign matter removing section configured to remove foreign matter adhering to the expander roller from a portion of an outer peripheral surface of the expander roller at which portion the expander roller is in no contact with the film.

2. The expander device according to claim 1, wherein:
The expander device may be configured such that the foreign matter removing section is an adhesive section; and
the adhesive section removes the foreign matter by causing the foreign matter to adhere to a surface of the adhesive section.

3. The expander device according to claim 2, wherein:
the expander roller is a curved expander roller having a curved axis; and
the adhesive section is an adhesive roller that has an axis curved in correspondence with a curvature of the axis of the expander roller and that is in contact with the expander roller in a longitudinal direction of the expander roller.

4. The expander device according to claim 1, wherein:
the foreign matter removing section is a sucking section having a sucking port; and
the sucking section removes the foreign matter by sucking the foreign matter through the sucking port.

5. The expander device according to claim 4, wherein:
the expander roller is a curved expander roller having a curved axis; and
the sucking port is curved in correspondence with a curvature of the axis of the expander roller and is near the expander roller in a longitudinal direction of the expander roller.

6. The expander device according to claim 1, wherein:
the foreign matter removing section is a scraper; and
the scraper removes the foreign matter by scraping the foreign matter.

7. The expander device according to claim 6, wherein:
the expander roller is a curved expander roller having a curved axis; and
the scraper is curved in correspondence with a curvature of the axis of the expander roller and is in contact with the expander roller in a longitudinal direction of the expander roller.

8. The expander device according to claim 1, wherein:
the outer peripheral surface is a smooth, curved surface.

9. The expander device according to claim 1, wherein:
the expander roller is a driving roller.

10. A porous film producing apparatus, comprising:
a transfer system including an expander device according to claim 1; and
a processing section configured to process the film, which is being transferred, into a porous film for a battery.

11. A porous film producing method for producing a porous film for a battery by processing a film while transferring the film with use of an expander roller extending in a width direction of the film and configured to apply a tension to the film in the width direction,
the porous film producing method comprising the step of removing foreign matter adhering to the expander roller from a portion of an outer peripheral surface of the expander roller at which portion the expander roller is in no contact with the film.

12. The porous film producing method according to claim 11, wherein
the foreign matter is removed from the portion of the outer peripheral surface while the film is being transferred.

13. The porous film producing method according to claim 11, wherein
the foreign matter is removed from the portion of the outer peripheral surface while the film is not being transferred.

14. The porous film producing method according to claim 13, wherein
in a case where supply of the film has been discontinued, transfer of the film is stopped, and the foreign matter is removed.

15. The porous film producing method according to claim 13, wherein
cutting the film in the width direction while the film is not being transferred and removing a cutting from a transfer path so that the film is in no contact with the expander roller;
removing the foreign matter; and
subsequently joining the cutting with a remainder of the film so that the film is transferrable.
